(19) United States
(12) Patent Application Publication
(10) Pub. No.: US 2010/0138588 A1
(43) Pub. Date: Jun. 3, 2010

(54) MEMORY CONTROLLER AND A METHOD OF OPERATING AN ELECTRICALLY ALTERABLE NON-VOLATILE MEMORY DEVICE

(75) Inventors: Fong Long Lin, Fremont, CA (US); Je-Hurn Shieh, Cupertino, CA (US)

Correspondence Address: DLA PIPER LLP (US ), 2000 UNIVERSITY AVENUE, EAST PALO ALTO, CA, 94303-2248, US

(73) Assignee: Silicon Storage Technology, Inc.

(21) Appl. No.: 12/326,811

(22) Filed: Dec. 2, 2008

(51) Int. Cl. G06F 12/02; G06F 12/00

(52) U.S. Cl. 711/103; 711/E12.001; 711/E12.008

(57) ABSTRACT

A controller operates a NAND non-volatile memory device which has an array of non-volatile memory cells. The array of non-volatile memory cells is susceptible to suffering loss of data stored in one or more memory cells of the array. The controller interfaces with a host device and receives from the host device a time-stamp signal. The controller comprises a processor, and a memory having program code stored therein for execution by the processor. The program code is configured to receive by the controller the time stamp signal from the host device; to compare the received time stamp signal with a stored signal wherein the stored signal is a time stamp signal received earlier in time by the controller from the host device; and to determine when to perform a data retention and refresh operation for data stored in the memory array based upon the comparing step.

### TECHNICAL HELD

The present invention relates to a memory controller and a method of operating an electrically alterable non-volatile memory device that is susceptible to suffering data loss over time.

### BACKGROUND OF THE INVENTION

Non-volatile memories are well known in the art. One example is an electrically alterable memory device. These non-volatile memory devices can be, for example, constructed of floating gate type or of trapping layer type. In either case, charges are either stored on a polysilicon floating gate or in an insulating trapping charge layer. One heretofore unknown fact is that depending on the design, some of these memory devices are unable to retain the charges stored for an extended period, such as five or more years. Because heretofore, applications for electrically alterable non-volatile memory devices have been in the consumer electronics area, the consumer has not sought the need to keep data stored accurately for many years. However, where these devices are to be used in industrial applications, there is a need for these devices to be able to retain the data stored on either the floating gate or on the trapping layer for an extended period of time.

One type of non-volatile memory manufactured by Silicon Storage Technology, Inc (SST) is a NOR device and is rated to retain for ten (10) years or more. However, the SST memory is suited to store program or code for execution by a processor or controller. When used to store data, especially a large amount of data, such usage may be expensive. In an effort reduce the cost, one type of memory that is explored for use is the NAND non-volatile memory. The NAND non-volatile memory is characterized by having a plurality of blocks with each block having a plurality of bits that are erased at the same time, with the block as a whole programmed at once. Although NAND non-volatile memories are less costly than me SST NOR type non-volatile memory on a cost per bit basis, they suffer from the problem of data retention.

In particular, it has been discovered that NAND non-volatile memories suffer from data loss read retention. In other words, after a NAND memory is programmed or has data storied therein, even if it is not subject to any electrical activity, such as read, write etc., data loss will occur over time. While this data loss may be insignificant for consumer applications (for which NAND memories were designed to be used for) for industrial applications and for long term storage, this data loss becomes unacceptable.

Accordingly, there is a need to solve the problem of data loss in non-volatile memories that are susceptible to such problem.

### SUMMARY OF THE INVENTION

Accordingly, in the present invention, a controller for operating a non-volatile memory device having an array of non-volatile memory cells, is disclosed. The array of non-volatile memory cells is susceptible to suffering loss of data stored in one or more memory cells of the array. The controller interfaces with a host device and receives from the host device a time-stamp signal The controller comprises a processor, and a memory having program code stored therein for execution by the processor. The program code is configured to receive by the controller the time stamp signal from the host device; to compare the received time stamp signal with a stored signal wherein the stored signal is a time stamp signal received earlier in time by the controller from the host device; and to determine when to perform a data retention and refresh operation for data stored in the memory array based upon the comparing step.

In addition, in the present invention, a controller for operating a non-volatile memory device having an array of non-volatile memory cells, is disclosed. The array of non-volatile memory cells has a plurality of blocks with each block having a plurality of memory cells that are erased together. The controller comprises a processor, and a memory having program code stored therein for execution by the processor. The program code is configured to a) read data from each of the memory cells from one of the blocks; b) correct the data read, if need be, to form corrected data; c) write corrected data, if exists, to a different block of the array, and not writing the data read if the data read is uncorrected; and d) to repeat the steps (a)-(c) for different blocks of the array until all of the blocks have been read.

The present invention also relates to a controller for operating a non-volatile memory device having an array of non-volatile memory cells. The array of non-volatile memory cells has a plurality of blocks with each block having a plurality of memory cells that are erased together. The controller comprises a processor, and a memory having program code stored therein for execution by the processor. The program code is configured to a) read the data signal from each of the memory cells from one of the blocks; b) compare the data signal read to a margin signal; c) write the data corresponding to the data signal into a different memory cell of a different block of the array, in the event the result of the comparing step (b) indicates the necessity of writing the data corresponding to the data signal to a different memory Cell, and not writing the data if otherwise; and d) repeat me steps (a)-(c) for different blocks of the array until all of the blocks have been read.

The present invention also relates to a method for performing each of the above-identified functions.

### BRIEF DESCRIPTION OF THE DRAWINGS

FIG. 1 is a block level diagram of a system of the present invention for carryout the method of the present invention.

FIG. 2 is a block level diagram of a NAND type memory capable of being used in the present invention.

### DETAILED DESCRIPTION OF THE PREFERRED EMBODIMENT

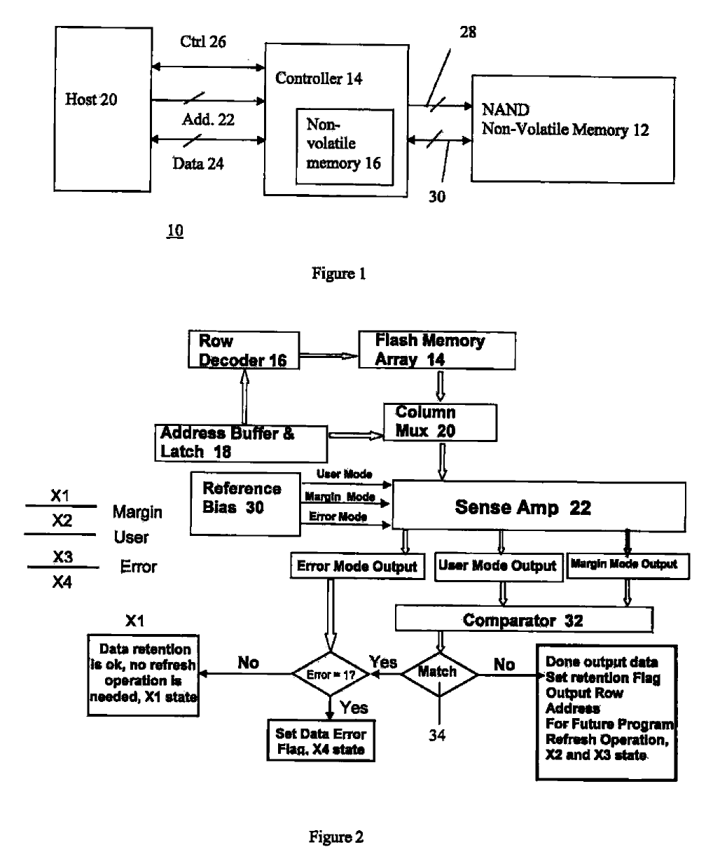

Referring to FIG. 1 there is a shown a system 10 for carrying out the method of the present invention. The system 10 comprises a non-volatile memory 12 such as a NAND memory 12. The system 10 also comprises a memory controller 14, which had a non-volatile memory 16 embedded therein. The non-volatile memory 16 is of the NOR type and preferably of the SST's NOR type such that data retention can be stored for a significant period of time without suffering any data loss. The non-volatile memory 16 is used to store a program code for operating the controller 14 and for carrying out the method of the present invention. Finally, the system comprises a host device 20 for interfacing with the memory controller 14.

The host device 20 is electrically connected to the controller 14 by an address bus 22, a data bus 24, and a controller bus 26. The buses 22,24, and 26 may 1>e connected serially, or in parallel. They may also be multiplexed on the same bus or separately supplied.

The controller 14 is connected to the NAND non-volatile memory 12 by an address bus 28 and a data bus 30. Again the buses 28 and 30 may be connected in parallel or serially. In addition, they may also be multiplexed. As is well known the NAND non-volatile memory 12 has a plurality of blocks with each block having a plurality of memory cells that are erased together at the same time.

In the method of the present invention, upon power up, the controller 14 retrieves the computer program code stored in the NOR non-volatile memory 16. The controller 14 then waits to receive a time stamp signal from the host device 20. The time stamp signal from the host device 20 indicates the “current” time. The controller 14 compares the “current” time as set forth in the time stamp signal with a time signal stored in the NOR non-volatile memory 16 to determine if sufficient time has passed since the last time, controller 14 has checked for the data retention of the NAND memory 12. If sufficient time has passed since the last time the controller 14 has checked the data retention of the NAND memory 12, then the controller 14 initiates the method to check for data retention.

In that event, the controller performs a data retention and refresh operation on the NAN memory 12 by reading data from each of the memory cells from one of the blocks in the NAND memory 12. Because the controller 12 has error correction coding, if the data read contains errors, then such data is corrected by the controller 14. The corrected data, if any, is then written back into the NAND memory device 14 in a block different from the block from which the data was read. In the event the data read is correct and does not require error correction, then the data is left stored in the current block. The controller 14 then proceeds to read the data for all the rest of the blocks of the NAND memory 12.

Alternatively, the controller 14 can compare the data read from each of the memory cells of a block with a margin signal. In the event the signal read from a memory cell is greater or less than the margin signal, for all the memory cells in a block, then the data is left stored in the block from which, it was read. However, in the event the signal from one of the memory cells of a block is greater or less than the margin signal, then all of the signals from the memory cells of a block are written into a block different from the block from which the signals from the memory cells were read.

Although the foregoing describes the host device 20 issuing a time stamp signal to the controller 14, the method of data retention operation can also be accomplished as follows. During normal operation, the host device 20 can issue a command to the controller 14 to initiate data retention check operation. Alternatively, each block of memory cells in the NAND device 12 may have a register associated therewith. During “normal” read operation, if the read operation shows the data either needs to be corrected or the signal from the memory cells read is outside of the margin compared to a margin signal, then the register associated with mat block is set Once register has been set, the blocks of the NAND device 12 may then be read and written to other locations.

Other possibilities to initiate the data retention method is to initiate the data retention operation upon either power up of power down of the controller 14, i.e. without waiting for a time stamp signal from the host device 20. Other possible initiation methods include the controller 14 having a hibernation circuit that periodically performs a data retention operation, wherein the data retention operation comprises reading data from blocks and either determining if the data is correct or is within a margin, and do nothing, or writing the data to a different blocks.

Referring to FIG. 2 there is shown a block level diagram of a NAND type memory 12 for use in the system 10 of the present invention. As is well known, the NAND memory 12 comprises an array 14 of NAND memory cells arranged in a plurality of rows and columns. An address buffer latch 18 receives address signals for addressing the array 14. A row decoder 16 decodes the address signals received in the address latch 18 and selects the appropriate row(s) of memory cells in the array 14. The selected memory cell(s) is (are) multiplexed through a column multiplexer 20 and are sensed by a sense amplifier 22. A reference bias circuit 30 generates three different sensing level signals (or margin signals), represented by four margin signals: X1, X2, X3, and X4 which are supplied to the sense amplifier 22 during the read operation.

The margin signal X1 provides the minimum margin signal required for data to retain at the maximum amount of charge on its floating gate. This will ensure enough charge retention for a certain period of time with requiring a refresh operation. The margin signal X2 is a user mode margin signal which is the normal margin read signal The margin signal X3 is a margin signal signifying an error mode and provides a flag which requires refresh operation if data stays at this level. Finally, the margin signal X4 is a margin signal which signifies that the data requires ECC (Error Correction Checking) protocol to correct it.

From the sense amplifier 22, there are three possible outputs: Margin Mode, User Mode, and Error Mode. If the signal is a Margin Mode output or a User Mode output, the signal is supplied to a comparator 32. From the comparator 32, the signal is supplied to a Match circuit 34. If the Match circuit 34 indicates a no match, then a flag for the particular row of memory cell that was addressed is set to indicate that a refresh operation needs to be performed.

If the Match circuit 34 indicates a match, then the controller 14 makes a determination if an error bit is set If not, then the data retention is within normal range and no refresh operation needs to be done. The Error Mode output of the sense amplifier 22 sets an error bit, even if the data is corrected by ECC. If the Error Bit is set, then the data is written to another portion of the Array 14 and a data refresh operation needs to be done.

What is claimed is:

1. A method of operating a non-volatile memory device having an array of non-volatile memory cells, susceptible to suffering loss of data stored in one or more memory cells of said array, and a controller for controlling the array of non-volatile memory cells, said memory device for interfacing with a host device and far receiving from the host device a time-stamp signal, said method comprising:
receiving by the controller the time stamp signal from the host device;
comparing the received time stamp signal with a stored signal wherein the stored signal is a time stamp signal received earlier in time by the controller from the host device; and
determining when to perform a data retention and refresh operation for data stored in (he memory array based upon the comparing step.

2. The method of claim 1 wherein the time stamp signal is sent by the host device upon power up of the memory device.

3. The method of claim 1 wherein the time stamp signal is sent by the host device after a hardware reset of the host device.

4. The method of claim 1 wherein the time stamp signal is sent by the host device after a software reset of the host device.

5. The method of claim 1 further comprising the step of
performing the data retention and refresh operation in the event the result of the comparing step indicates the necessity of performing such operation.

6. The method of claim 5 wherein the array of non-volatile memory cells has a plurality of blocks with each block having a plurality of memory cells mat are erased together, and wherein the controller having capability for detecting and correcting one or more errors in data stored in a block of memory cells.

7. The method of claim 6 wherein the data retention and refresh operation comprises:
a) reading data from each of the memory cells from one of said blocks;
b) correcting said data read, if need be, to form corrected data, by the controller,
c) writing corrected data, if exists, to a different block of said array; and
d) repeating the steps (a)-(c) for different blocks of the array until all of the blocks have been read.

8. The method of claim 6 wherein the data retention and refresh operation comprises:
a) reading the data signal from each of the memory cells from one of said blocks;
b) comparing the data signal read to a margin signal;
c) writing the data corresponding to the data signal into a different memory cell of a different block of said array, in the event the result of the comparing step (b) indicates the necessity of writing the data corresponding to the data signal to a different memory cell; and
d) repeating the steps (a)-(c) for different blocks of the array until all of the blocks have been read.

9. A method of determining the integrity of data signals stored in an array of non-volatile memory cells, wherein the array of non-volatile memory cells is characterized by a plurality of blocks with each block having a plurality of non-volatile memory cells that are erased together, said method comprising:
a) reading data from each of the memory cells from one of said blocks;
b) correcting said data read, if need be, to form corrected data;
c) writing corrected data, if exists, to a different block of said array, and not writing the data read if the data read is uncorrected; and
d) repeating the steps (a)-(c) for different blocks of the array until all of the blocks have been read.

10. A method of determining the integrity of data signals stored in an array of non-volatile memory cells, wherein the array of non-volatile memory cells is characterized by a plurality of blocks with each block having a plurality of non-volatile memory cells that are erased together, said method comprising:
a) reading the data signal from each of the memory cells from one of said blocks;
b) comparing the data signal read to a margin signal;
c) writing the data corresponding to the data signal into a different memory cell of a different block of said array, in the event the result of the comparing step (b) indicates the necessity of writing the data corresponding to the data signal to a different memory cell, and not writing the data if otherwise; and
d) repeating the steps (a)-(c) for different blocks of the array until all of the blocks have been read.

11. A controller for operating a non-volatile memory device having an array of non-volatile memory cells, susceptible to suffering loss of data stored in one or more memory cells of said array, said controller for interfacing with a host device and for receiving, from the host device a time-stamp signal, said controller comprising:
a processor;
a memory having program code stored therein for execution by the processor, said program code configured to:
receiving by the controller the time stamp signal from the host device;
comparing the received time stamp signal with a stored signal wherein the stored signal is a time stamp signal received earlier in time by the controller from the host device; and
determining when to perform a data retention and refresh operation for data stored in the memory array based upon the comparing step.

12. The controller of claim 11 wherein said an array of non-volatile memory cells has a plurality of blocks with each block having a plurality of memory cells that are erased together, wherein said program code is further configured to:
a) reading data from each of the memory cells from one of said blocks;
b) correcting said data read, if need be, to form corrected data, by the controller;
c) writing corrected data, if exists, to a different block of said array; and
d) repeating the steps (a)-(c) for different blocks of the array until all of the blocks have been read.

13. The controller of claim 11 wherein said an array of non-volatile memory cells has a plurality of blocks with each block having a plurality of memory cells that are erased together, wherein said program code is further configured to:
a) reading the data signal from each of the memory cells from one of said blocks;
b) comparing the data signal read to a margin signal;
c) writing the data corresponding to the data signal into a different memory cell of a different block of said array, in the event the result of the comparing step (b) indicates the necessity of writing the data corresponding to the data signal to a different memory cell; and
d) repeating the steps (a)-(c) for different blocks of the array until all of the blocks have been read.

14. A controller for operating a non-volatile memory device having an array of non-volatile memory cells, with said array of non-volatile memory cells having a plurality of blocks with each block having a plurality of memory cells that are erased together, said controller comprising:
a processor;
a memory having program code stored therein for execution by the processor, said program code configured to:
a) reading data from each of the memory cells from one of said blocks;
b) correcting said data read, if need be, to form corrected data;
c) writing corrected data, if exists, to a different block of said array, and not writing the data read if the data read is uncorrected; and
d) repeating the steps (a)-(c) for different blocks of the array until all of the blocks have been read.

15. A controller for operating a non-volatile memory device having an array of non-volatile memory cells, with said array of non-volatile memory cells having a plurality of blocks with each block having a plurality of memory cells that are erased together, said controller comprising:
a processor;
a memory having program code stored therein for execution by the processor, said program code configured to:
a) reading the data signal from each of the memory cells from one of said blocks;
b) comparing the data signal read to a margin signal;
c) writing the data corresponding to the data signal into a different memory cell of a different block of said array, in the event the result of the comparing step (b) indicates the necessity of writing the data corresponding to the data signal to a different memory cell, and not writing the data if otherwise; and
d) repeating the steps (a)-(c) for different blocks of the array until all of the blocks have been read.
